(19) United States
(12) Patent Application Publication
(10) Pub. No.: US 2017/0190294 A1
(43) Pub. Date: Jul. 6, 2017

(54) Step Attachment Device

(71) Applicant: Tyler S. Swanson, Crosby, ND (US)

(72) Inventor: Tyler S. Swanson, Crosby, ND (US)

(21) Appl. No.: 14/987,948

(22) Filed: Jan. 5, 2016

(51) Int. Cl. B60R 3/00

(52) U.S. Cl. CPC B60R 3/007

(57) ABSTRACT

A step attachment device which attaches to the fender of a vehicle such as a road grader to provide easy access to the engine compartment or other locations during service or repair. The step attachment device generally includes a bracket adapted to be secured to a vehicle and a step attachment which is pivotally connected to the bracket. The bracket includes an inner end which is connected to the vehicle using second openings and fasteners. The step attachment is pivotally connected to the outer end of the bracket via a fastener and pivot mount. The step attachment is pivotable between at least two positions: a first raised position in which the step attachment rests on the upper end of the bracket and a second lowered position in which the step attachment extends from the bracket for use as a step.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

Field of the Invention

The present invention relates generally to a step and more specifically it relates to a step attachment device which attaches to the fender of a vehicle such as a road grader to provide easy access to the engine compartment or other locations during service or repair.

Description of the Related Art

Any discussion of the related art throughout the specification should in no way be considered as an admission that such related art is widely known or forms part of common general knowledge in the field.

Large vehicles with heightened wheelbases are common throughout a wide range of industries. From trucks being used to convey goods across the country to road graders being used by work crews, the use of such heavy duty vehicles is prominent. However, such vehicles typically have large, raised engine compartments that are simply not possible to reach, let alone work in, without elevating an individual to the level of the compartments.

In the past, it has been necessary to bring a stool, ladder, or other device and place it adjacent to the engine compartment in order to elevate oneself to the height necessary to safely service or repair such a vehicle. Often, workers will take unnecessary risks by utilizing random objects as stools or the like. This is particularly dangerous when you are working at a height with engine parts of such a large vehicle.

Because of the inherent problems with the related art, there is a need for a new and improved step attachment device which attaches to the fender of a vehicle such as a road grader to provide easy access to the engine compartment or other locations during service or repair.

### BRIEF SUMMARY OF THE INVENTION

Provided herein is a step which includes a bracket adapted to be secured to a vehicle and a step attachment which is pivotally connected to the bracket. The bracket includes an inner end which is connected to the vehicle using second openings and fasteners. The step attachment is pivotally connected to the outer end of the bracket via a fastener and pivot mount. The step attachment is pivotable between at least two positions: a first raised position in which the step attachment rests on the upper end of the bracket and a second lowered position in which the step attachment extends from the bracket for use as a step.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of a step attachment device in use on a road grader.

FIG. 2 is a side perspective view of the present invention in use on a road grader.

FIG. 3 is an upper perspective view of the present invention in a lowered position while installed between two wheels of a vehicle.

FIG. 4 is a frontal upper perspective view of the present invention in a raised position.

FIG. 5 is a rear perspective view of the present invention.

FIG. 6 is an upper perspective view of the present invention in a lowered position for use.

FIG. 7 is an exploded view of the present invention.

FIG. 8 is a side view of the present invention in a raised position.

FIG. 9 is a side view of the present invention in a lowered position.

### DETAILED DESCRIPTION OF THE INVENTION

### A. Overview

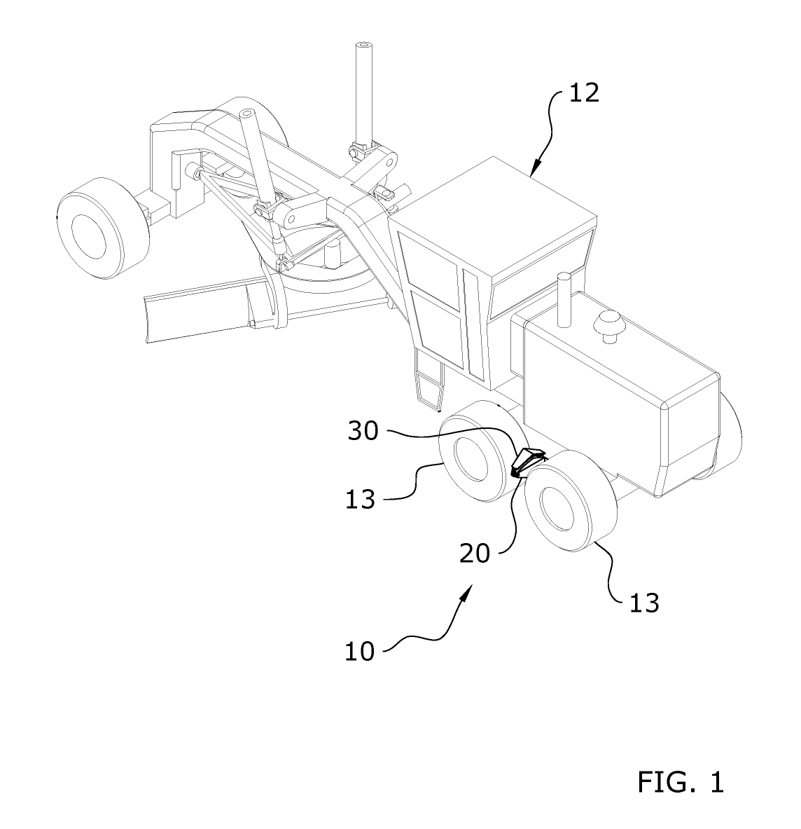

Turning now descriptively to the drawings, in which similar reference characters denote similar elements throughout the several views, FIGS. 1 through 9 illustrate a step attachment device 10, which comprises a bracket 20 adapted to be secured to a vehicle 12 and a step attachment 30 which is pivotally connected to the bracket 20. The bracket 20 includes an inner end 24 which is connected to the vehicle 12 using second openings 29 and fasteners 15. The step attachment 30 is pivotally connected to the outer end 23 of the bracket 20 via a fastener 15 and pivot mount 34. The step attachment 30 is pivotable between at least two positions: a first raised position in which the step attachment 30 rests on the upper end 21 of the bracket 20 and a second lowered position in which the step attachment 30 extends from the bracket 20 for use as a step.

### B. Bracket

As shown throughout the figures, the present invention includes a bracket 20 which is connected to a vehicle 12 and to which the step attachment 30 is rotatably connected. The shape, size, configuration, and orientation of the bracket 20 may vary in different embodiments for different applications, and thus should not be construed as limited by the exemplary figures. The positioning of the bracket 20 on the vehicle 12 may also vary in different embodiments and for different applications. The positioning shown in the figures with the bracket 20 being installed between two wheels 13 should thus not be construed as limiting on the scope of the present invention.

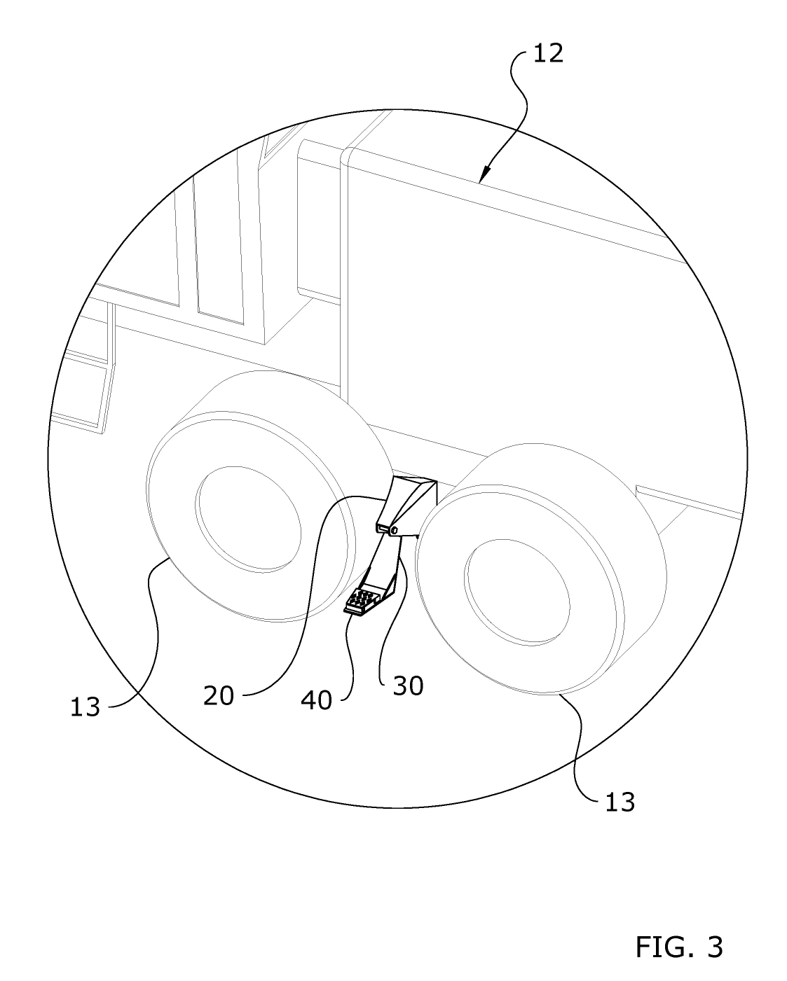

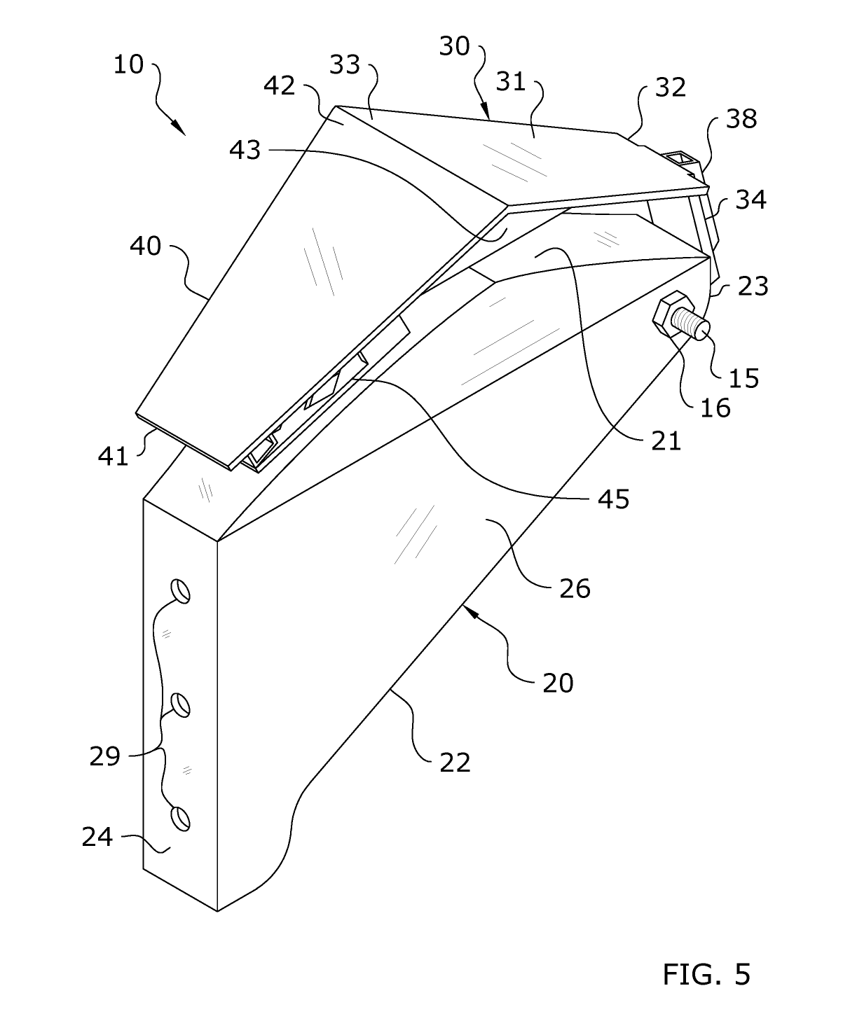

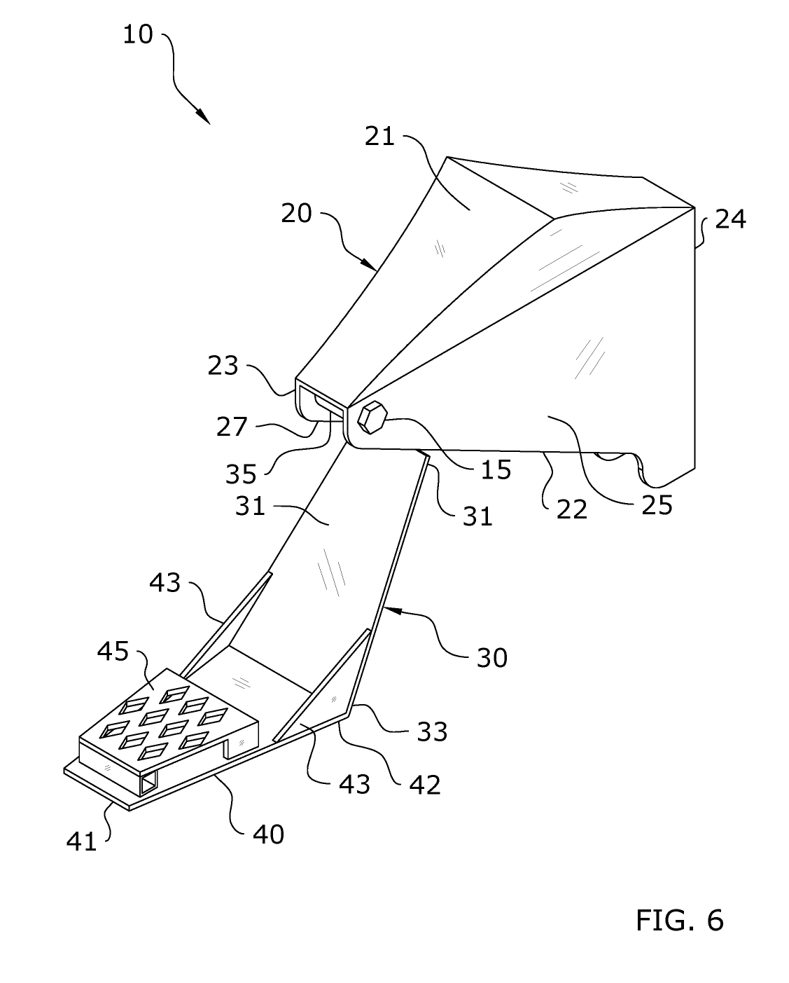

As best shown in FIG. 3, the bracket 20 comprises an upper end 21, a lower end 22, an outer end 23, an inner end 24, a first side 25, and a second side 26. The upper end 21 of the bracket 20 may comprise a triangular configuration as shown in the figures in some embodiments. Thus, the upper end 21 of the bracket 20 slopes upwardly from its first side 25 and second side 26 to converge at an elevated point as shown in FIG. 6. This configuration allows the step 30 (which is similarly-shaped) to rest on the upper end 21 of the bracket 20 as shown in FIG. 5. The upper end 21 may also be tapered in both directions as shown in the figures.

As shown in FIG. 6, the lower end 22 of the bracket 22 may be tapered from its inner end 24 to its outer end 23. The lower end 22 of the bracket 22 generally includes a slot 27 in which portions of the step attachment 30, such as its attachment portion 31 as shown in FIG. 6, are positioned during use of the present invention. Generally, the slot 27 is defined by the first and second sides 25, 26 of the bracket 22. The shape, orientation, positioning, and dimensions of the slot 27 may vary in different embodiments.

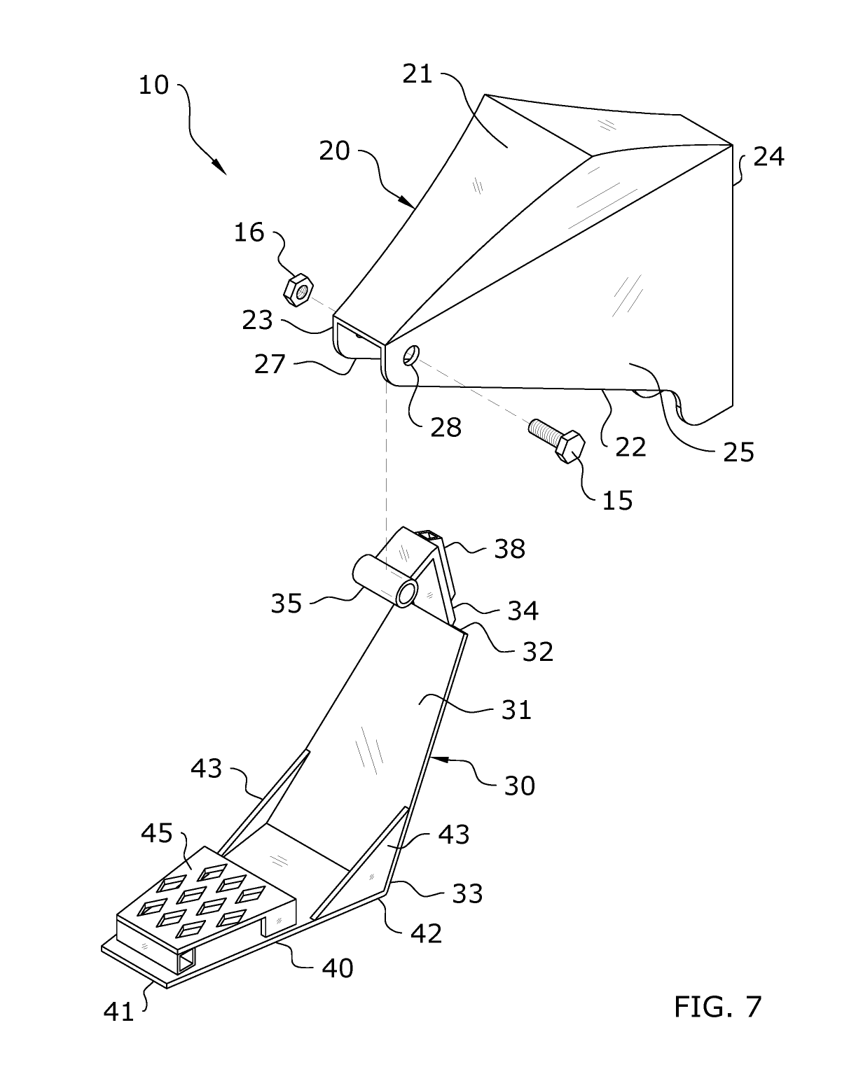

The outer end 23 of the bracket 20 faces away from the vehicle 12 and generally includes one or more first openings 28 which are utilized to pivotally connect the bracket 20 and the step attachment 30. As shown in FIG. 7, a preferred embodiment utilizes first openings 28 which are positioned on the first and second sides 25, 26 of the bracket 20 near its outer end 23. A fastener 15 and bolt 16 may be extended through the first openings 28 to pivotally connect the bracket 20 and step attachment 30.

Various other configurations may be utilized for the pivotal connection, however, and in some embodiments the first openings 28 may be omitted and an integral pivot pin utilized. In the embodiment shown in the figures, the fastener 15 is removably secured within the first openings 28 so that the bracket 20 and step attachment 30 may be removably connected in a pivotal manner and thus disconnected for servicing or repair.

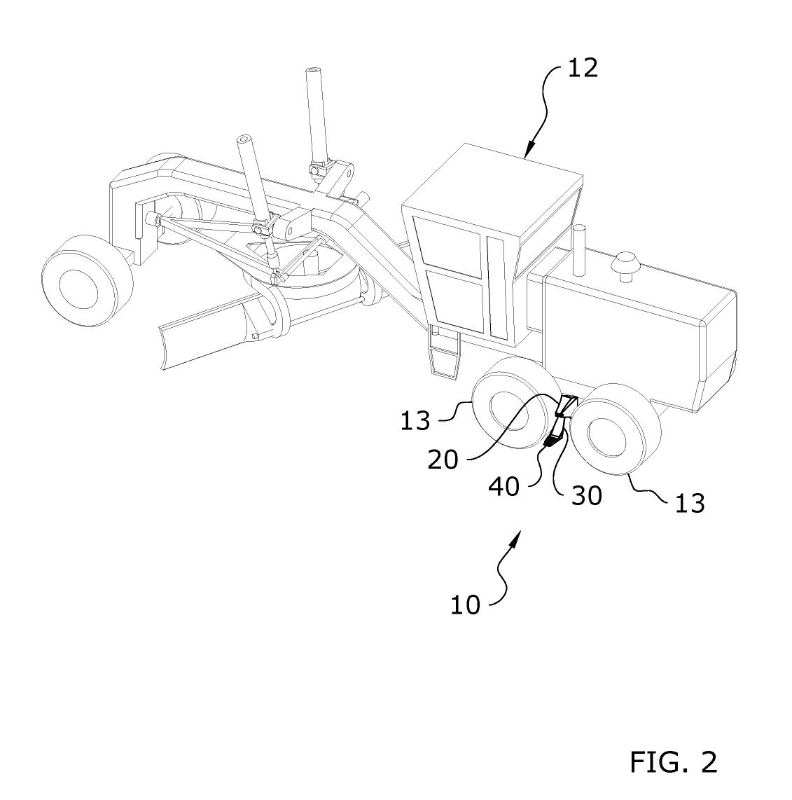

The inner end 24 of the bracket 20 is connected (removably or fixedly) to the vehicle 12 as shown in FIGS. 1 and 2. The inner end 24 of the bracket 20 thus may include one or more second openings 29 which are utilized to secure the bracket 20 to the vehicle 12. Although the figures illustrate three vertically-aligned second openings 29, it should be appreciated that more or less second openings 29 may be utilized depending on the embodiment. The second openings 29 may also be omitted in some embodiments if other means are utilized for connecting the bracket 20 to the vehicle 12. In some embodiments, the bracket 20 may be integral with the vehicle 12.

### C. Step Attachment

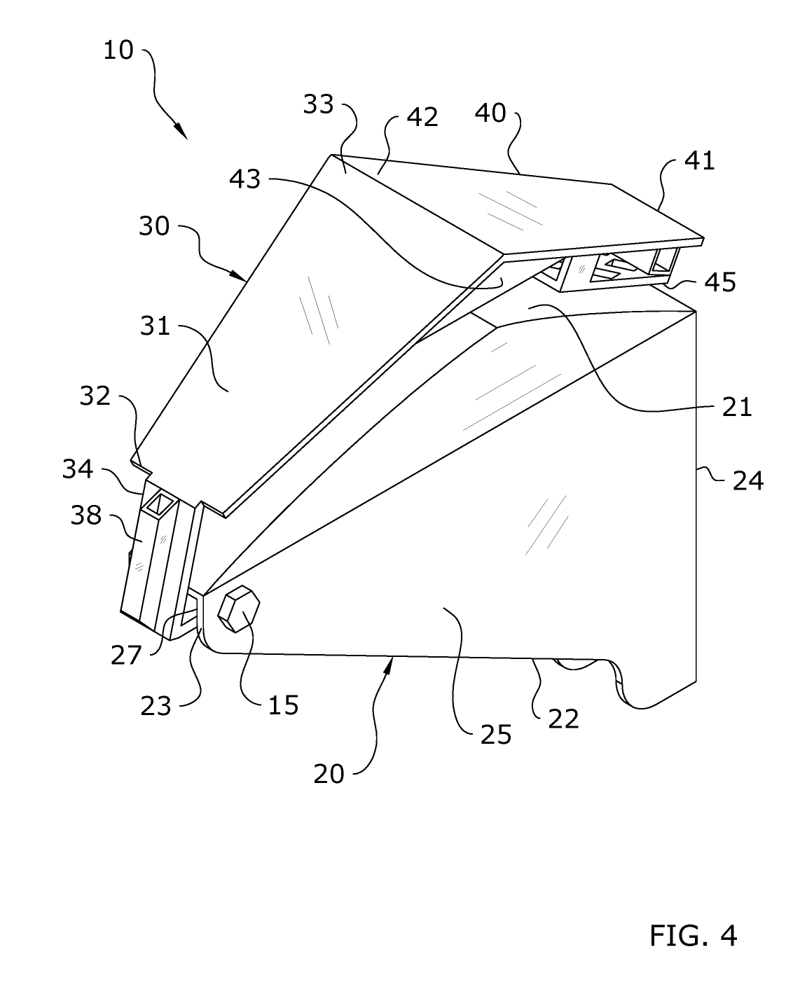

As best shown in FIGS. 3 and 4, a step attachment 30 is pivotally connected to the bracket 20, such as to the bracket's 20 outer end 23. The step attachment 30 is pivotally connected such that it may be oriented in at least two positions: a raised position for when not in use as shown in FIG. 5 and a lowered position for use as shown in FIG. 6. In a preferred embodiment, the step attachment 30 comprises an L-shaped configuration, though other configurations may be utilized.

As shown in FIG. 6, the step attachment 30 generally comprises an attachment portion 31 and a step portion 40 which are fixedly attached or integral with each other. The attachment portion 31 of the step attachment 30 is pivotally connected to the bracket 20 such that the step attachment 30 pivots about the attachment portion 31. The step portion 40 extends from the attachment portion 31 at an angle and is utilized as a structure to step onto or stand on when the present invention is in use.

The attachment portion 31 may comprise a first end 32 and a second end 33 as shown in FIG. 6. The first end 32 of the attachment portion 31 may include a pivot mount 34 extending outwardly. The pivot mount 34 may comprise various configurations, but will preferably comprise an L-shaped configuration such that the pivot mount 34 will itself act as a stop to prevent full pivoting rotation of the step attachment 30 with respect to the bracket 20. When rotated a certain distance in a direction, the pivot mount 34 will contact the bracket 20 within its slot 27 to prevent additional rotation in that direction.

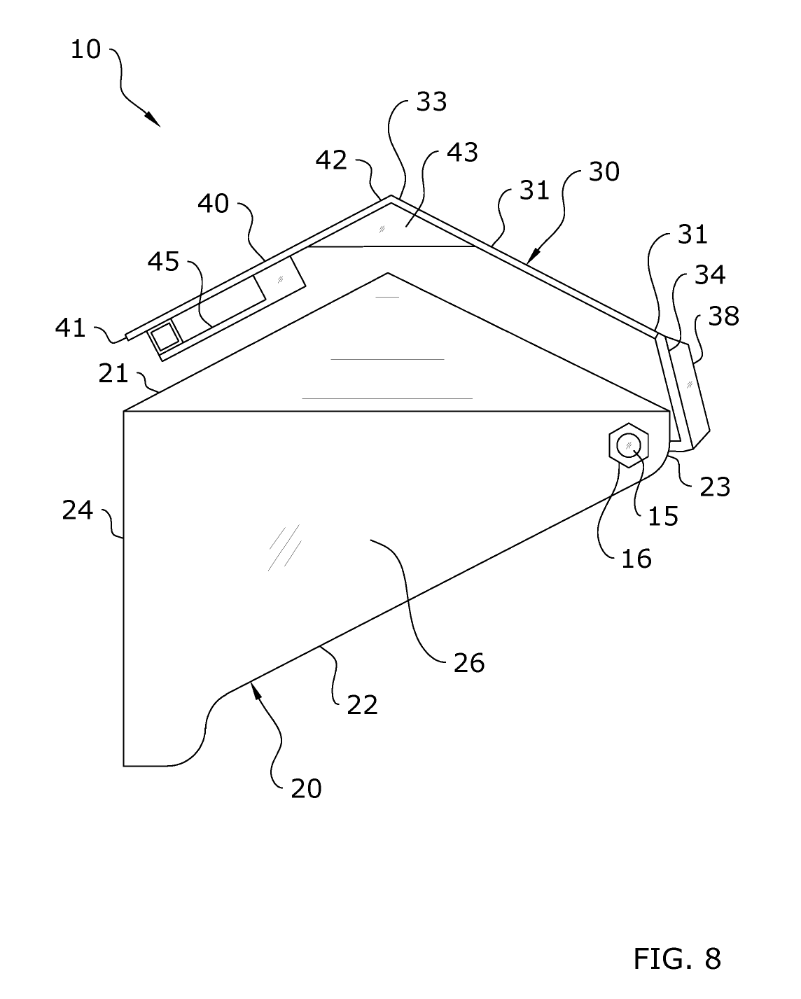

As shown in FIG. 7, the pivot mount 34 may include a receiver 35. The receiver 35 may comprise a tubular member with an opening through which a fastener 15 may be extended to pivotally connect the step attachment 30 to the bracket 20. The receiver 35 is generally thus aligned with the first openings 28 of the bracket 20 such that a fastener 15 may extend through both the first openings 28 of the bracket 20 and the receiver 35 of the pivot mount 34 to effectuate the pivotal connection. The pivot mount 34 may also include a brace 38 as shown in FIG. 8, which improves structural integrity of the pivot mount 34 and attachment portion 31 of the step attachment 30.

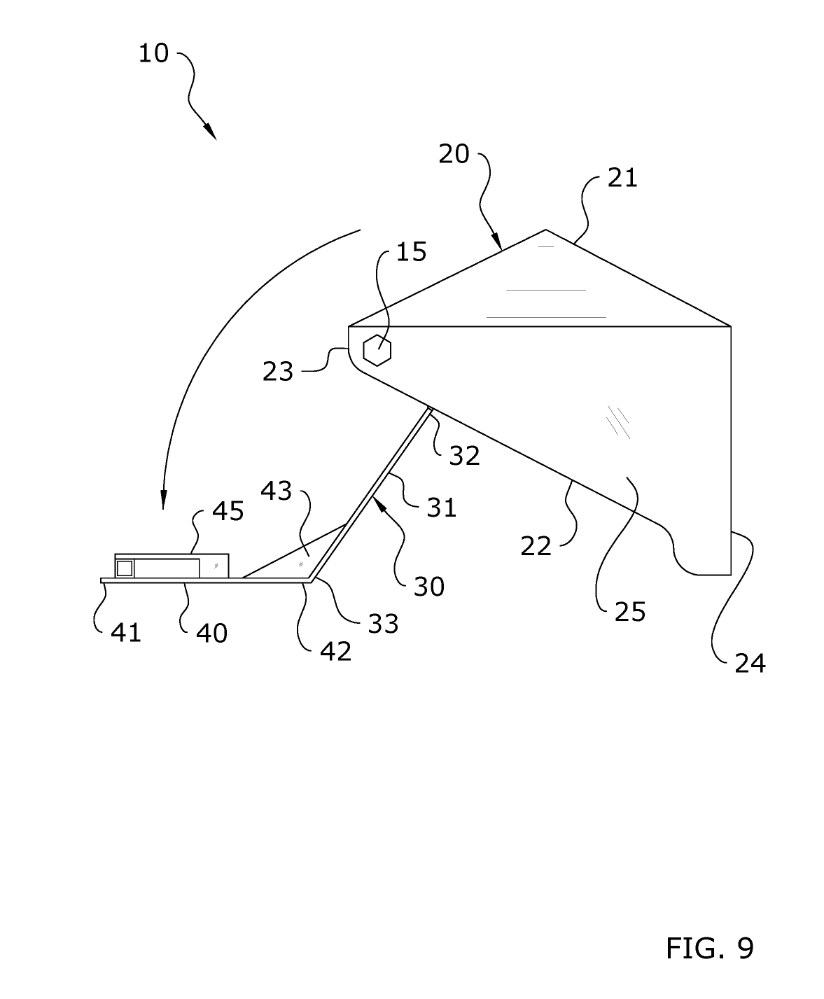

As shown in FIG. 9, the step portion 40 extends from the attachment portion 31 of the step attachment 30. One or more reinforcement members 43 may be connected between the step portion 40 and the attachment portion 31 as shown in the figures to reinforce the interconnection therebetween.

The step portion 40 is the portion of the present invention upon which an individual will stand when the present invention is in use. The inner end 42 of the step portion 40 is connected to or integrally formed with the second end 33 of the step attachment 30. The outer end 41 of the step portion 40 may include a raised grip 45 as shown in the figures which increase traction when standing upon the step portion 40.

### D. Operation of Preferred Embodiment

In use, the bracket 20 is first secured to the vehicle 12. The bracket 20 may be connected to various locations on the vehicle 12 to provide access to raised areas of the vehicle 12 that may not be accessible without some elevation. In the embodiment shown in the figures, the bracket 20 is installed on the side of the vehicle 12 between two of its wheels 13. This particular positioning provides access to a raised engine compartment of a road grader 12 and should not be construed as limiting on the scope of the present invention.

The inner end 24 of the bracket 20 is preferably connected to the vehicle 12. In some embodiments, the bracket 20 may be fixedly attached or integral with the vehicle 12. In the embodiment shown in the figures, the bracket 20 is removably attached to the vehicle 12. To removably connect the bracket 20, the inner end 24 of the bracket 20 is positioned against the vehicle 12. Fasteners 15 may be extended through the second openings 29 of the bracket 20 which are best shown in FIG. 5. Thus, the second openings 29 of the bracket 20 may be utilized to secure the bracket 20 against the vehicle.

With the bracket 20 secured to the vehicle 12, the step attachment 30 may be installed. While this exemplary description describes the step attachment 30 being connected to the bracket 20 after the bracket 20 has been connected to the vehicle 12, this order may be reversed and the bracket 20 and the step attachment 30 may be secured to each other prior to the bracket 20 being installed on the vehicle 12. In some embodiments, the bracket 20 and step attachment 30 may be fixedly connected to each other.

To connect the step attachment 30 to the bracket 20, the step attachment 30 is oriented such that the pivot mount 34 of its attachment portion 31 is positioned within the slot 27 of the bracket 20 adjacent to its outer end 23 as shown in FIGS. 6 and 7. The receiver 35 of the pivot mount 34 is aligned with the first openings 28 of the bracket 20 such that a fastener 15 may be inserted through both the first openings 28 of the bracket 20 and the receiver 35 of the pivot mount 34. A bolt 16 may be utilized to secure the connection. When so installed, the fastener 15 should be rotatable within the first openings 28 such that the step attachment 30 may be rotated between its raised and lowered positions.

With the step attachment 30 and bracket 20 pivotally connected to each other, the present invention may be used. The use the step attachment 30, the step attachment 30 is drawn downwardly so that it pivots into its lowered position as shown in FIG. 9. An individual may then step onto the step attachment 30 to provide easier access to elevated structures on the vehicle 12. The raised grip 45 of the step attachment 30 will provide traction so that the individual is less likely to fall off the present invention while in use. When completed with work, the step attachment 30 may be pivoted back upwardly into its raised, resting position awaiting further use.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A step attachment device, comprising:
a bracket comprising an inner end and an outer end, wherein the inner end of the bracket is connected to a vehicle; and
a step attachment pivotally connected to the outer end of the bracket, wherein the step attachment is adjustable between a first raised position and a second lowered position.

2. The step attachment device of claim 1, wherein the step attachment rests on the bracket when in the first raised position.

3. The step attachment device of claim 1, wherein the bracket comprises an upper end and a lower end, wherein the upper end of the bracket is tapered.

4. The step attachment device of claim 3, wherein the lower end of the bracket includes a slot.

5. The step attachment device of claim 3, wherein the step attachment is tapered.

6. The step attachment device of claim 1, wherein the step attachment comprises an L-shaped configuration.

7. The step attachment device of claim 6, wherein the step attachment comprises an attachment portion and a step portion.

8. The step attachment device of claim 7, further comprising one or more reinforcement members connected between the attachment portion and the step portion of the step attachment.

9. The step attachment device of claim 1, wherein the step attachment includes a pivot mount, wherein the pivot mount is pivotally connected to the outer end of the bracket.

10. The step attachment device of claim 1, wherein the bracket is removably connected to the vehicle.

11. A step attachment device, comprising:
a bracket comprising an inner end and an outer end, wherein the inner end of the bracket is connected to a vehicle; and
a step attachment comprising an attachment portion and a step portion, wherein the attachment portion is pivotally connected to the outer end of the bracket, wherein the step portion is adjustable between a first raised position and a second lowered position by pivoting the attachment portion with respect to the bracket.

12. The step attachment device of claim 11, wherein the step portion rests on an upper end of the bracket when in the first raised position.

13. The step attachment device of claim 11, wherein the attachment portion includes a pivot mount.

14. The step attachment device of claim 13, wherein the outer end of the bracket includes one or more first openings.

15. The step attachment device of claim 14, wherein the pivot mount is pivotally connected to the bracket by one or more fasteners extending through the first openings and the pivot mount.

16. The step attachment device of claim 11, wherein the step attachment includes a raised grip.

17. The step attachment device of claim 11, further comprising one or more reinforcement members connected between the attachment portion and the step portion of the step attachment.

18. The step attachment device of claim 11, wherein the attachment portion includes a brace.

19. The step attachment device of claim 11, wherein the bracket includes a slot.

20. The step attachment device of claim 19, wherein a pivot mount extending from the step attachment is rotatably positioned within the slot.
